(19) United States
(12) Patent Application Publication
(10) Pub. No.: US 2011/0244204 A1
(43) Pub. Date: Oct. 6, 2011

(54) TEXTILE SUPPORT FOR BITUMINOUS MEMBRANE WITH HIGH DIMENSIONAL STABILITY, PARTICULARLY FOR WATERPROOFING BUILDINGS

(76) Inventors: Massimo Migliavacca, Milano (IT); Stefano Turri, Brugherio (IT); Marinella Levi, Milano (IT)

(21) Appl. No.: 13/133,758

(22) PCT Filed: Dec. 12, 2008
(86) PCT No.: PCT/EP2008/067446

§ 371 Date: Jun. 9, 2011

(51) Int. Cl. B32B 5/26

(52) U.S. Cl. 428/219; 442/381

(57) ABSTRACT

The present invention concerns a textile support for bituminous membranes, particularly for waterproofing roof surfaces of buildings, characterised by a high dimensional stability. The support comprises at least two layers (1, 2) of non-woven polyester or polymeric material in general and a plurality of longitudinal reinforcing filaments (3). The reinforcing filaments (3), preferably of glass, have been treated in advance with a size which allows the formation of stable chemical bonds, not strongly influenced by temperature.

The use is known, in building, of bituminous membranes for waterproofing the roofs of buildings or of sealing surfaces. The use is also known of non-woven textile material produced from polyester fibres as a textile support within said membranes.

These articles, on the one hand, require great dimensional stability both during laying and during ageing; on the other hand they are subjected in the course of manufacture to significant stresses, both mechanical and thermal.

These membranes are in fact made by impregnating the textile supports in a bath of bituminous mixtures maintained at a temperature that can reach 200° C.; during processing, furthermore, the textile support undergoes mechanical stresses, typically traction strains predominantly in a longitudinal direction, which can even bring about significant deformation because of the joint action of the temperature of the mass of bitumen and the above-mentioned traction strains.

At the end of this procedure, the membranes are cooled, and rolled so that they can subsequently be sold, ready for laying on buildings. If the support has undergone significant stress and/or deformation (elongation or shrinkage) during the process, internal tensions are generated which remain in the finished product (bituminous membrane) as a result of cooling in conditions where relaxation is prevented. These latent tensions are released as soon as sufficient energy is supplied to the product to activate them, for example during heating as part of the laying operation, or as a result of solar radiation. The consequences include shrinkage and distortion which can cause the formation of undulations, and can even cause the joints to slide until the impermeability of the membrane is compromised.

For this reason the search has been developed for systems which can increase the strength and the stability of the supports, especially by the use of various kinds of reinforcement.

In particular, supports have been perfected which use as reinforcement threads arranged in a longitudinal direction, made up of inorganic and/or organic fibres, inserted between two layers of polymeric material, mechanically, thermally and chemically linked so as to improve the mechanical performance of the composite support at the stage of production of the membrane.

For example, U.S. Pat. No. 5,118,550 uses glass filaments as reinforcing threads, which confer on the product a high modulus of elasticity in a longitudinal direction, both at room temperature and, especially, at the temperatures at which it is impregnated with bitumen.

The efficacy of the reinforcing action of the glass filaments in relation to the fibrous structure, measured in terms of the increase in the modulus of elasticity of the material in a longitudinal direction, compared with a support which lacks reinforcing fibres, depends essentially on the quality of the mechanical and chemical bonding between the two layers into which the reinforcing thread itself is inserted.

The mechanical and chemical bonding prevents the glass threads from sliding within the two layers of non-woven textile, both in a transverse and in a longitudinal direction.

It is obvious that preventing the filaments from sliding in a longitudinal direction is in large part dependent on the characteristics of the chemical bonding agent (generally styrol-acrylic or styrol-butadiene resins) and on chemical and physical adhesion forces which are established between the glass reinforcing fibres and the polymeric matrix of the non-woven textile.

These forces and the efficacy of the bond are strongly influenced by temperature.

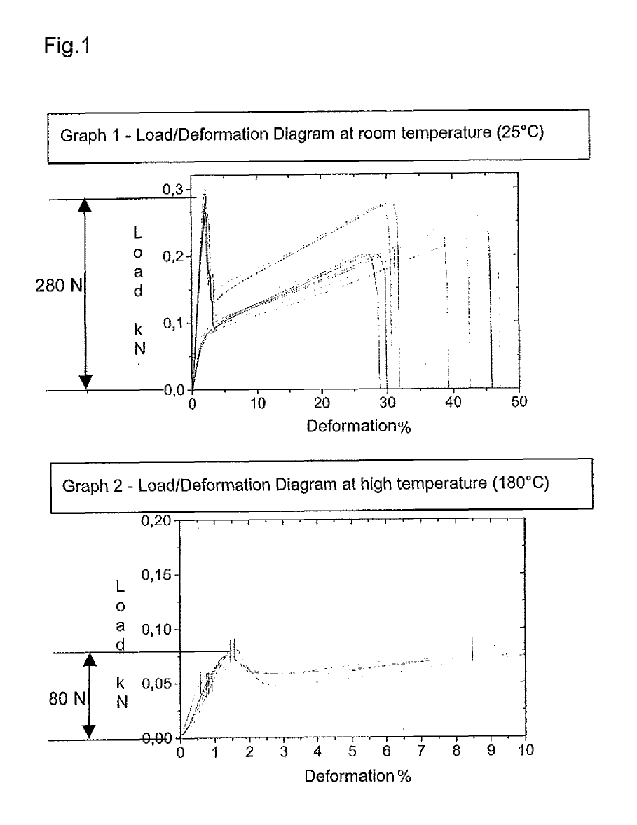

As is obvious from a comparison between graphs 1 and 2 in FIG. 1, there is a significant deterioration in the mechanical characteristics (modulus of elasticity and yield peak) of the support for coverings when stressed at high temperature compared with the same support stressed at room temperature.

This deterioration is a consequence precisely of the reduction in the forces of cohesion between the fibrous matrix and the reinforcing filaments.

The modulus of elasticity of composite materials, in particular of reinforced non-woven textiles, is strongly influenced by the intensity of the superficial bonds which are established between the fibrous matrix and the reinforcing filaments. The greater the collaboration between the two components, the better will be the performance of the composite, exploiting to the maximum the peculiar characteristics of each of the components (in the specific case, the mechanical strength of the reinforcement and the elasticity and tenacity of the matrix).

In the case of the support in question, whose matrix is made up of polyester fibre and whose reinforcement is provided by glass filaments, the collaboration between the two components has been optimised by the addition of an additive to the surface of the glass filaments which increases the forces of cohesion between the inorganic filaments of the reinforcement and the organic fibres of the matrix through the formation of chemical bonds.

The object of the present invention is to further increase the forces of adhesion between the glass reinforcing threads and the fibrous polymeric matrix under all temperature conditions.

This object is achieved by means of a textile support for a bituminous membrane, comprising at least two layers of non-woven polyester or polymeric material in general and a plurality of longitudinal reinforcing threads, characterised in that said reinforcing have been treated in advance with a size which allows the formation of stable chemical bonds, not strongly influenced by temperature.

The chemical bond which is thus established intimately bonds the surface of the reinforcing threads, particularly if these consist of glass filaments, and the functional groups present in the fibrous matrix of the non-woven layers or present in the added chemical bonding agent.

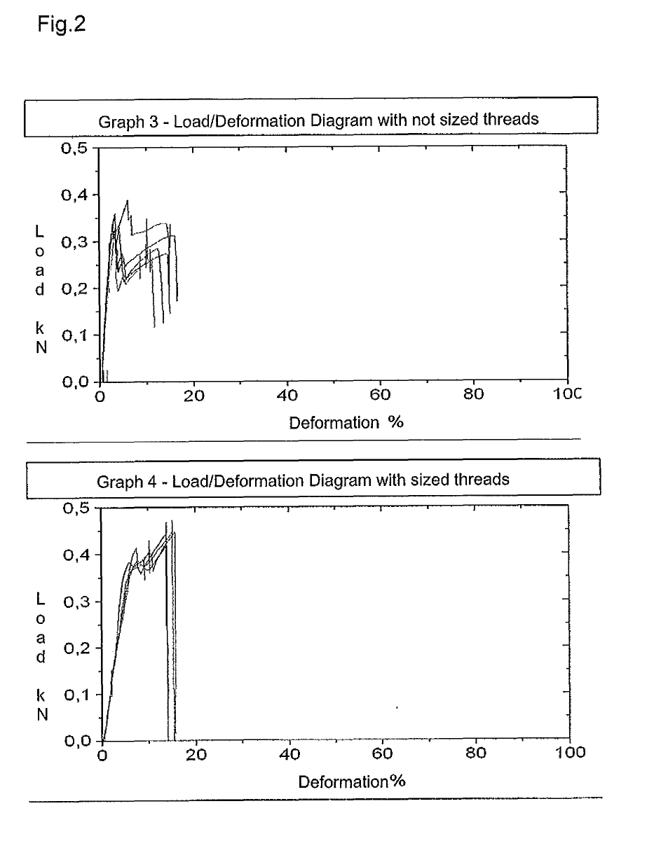

The increase in the forces of adhesion achieved as a result of the present invention, observable from graphs 3 and 4 in FIG. 2, enables an improvement in the mechanical performance of the support for bituminous membranes, by increasing the longitudinal elastic modulus, especially in temperature conditions typical of the procedure for impregnation with bitumen.

The support for bituminous membranes produced according to the present invention is capable of tolerating the mechanical stresses which are generated in the impregnation process without undergoing excessive deformation, thus allowing the production of bituminous membranes of better quality, characterised by high dimensional stability.

The support in question, as a result of its better mechanical performance, also enables an increase in the speed of production of the membranes, thus allowing significant reductions in their production costs.

The non-woven textile layers can be made up of polyester flock fibres, or of an intimate mixture of thermoplastic fibres, typically polyester, but also polyamide 6 or 66, PBT etc., or of films of continuous threads deposited on a mesh.

These and other characteristics of the present invention will be made clearer by the following description of a practical embodiment thereof, described without limiting effect by reference to the attached drawings, wherein:

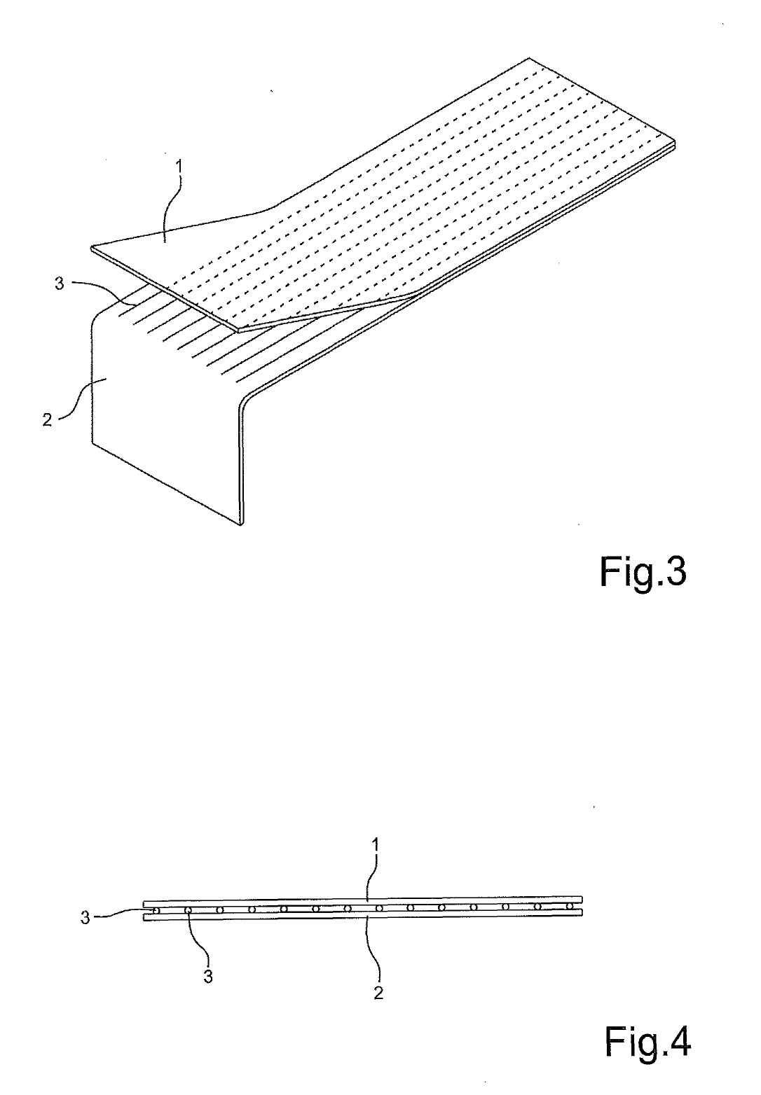

FIG. 3 shows in perspective a textile support according to the present invention;

FIG. 4 shows said textile support in transverse section;

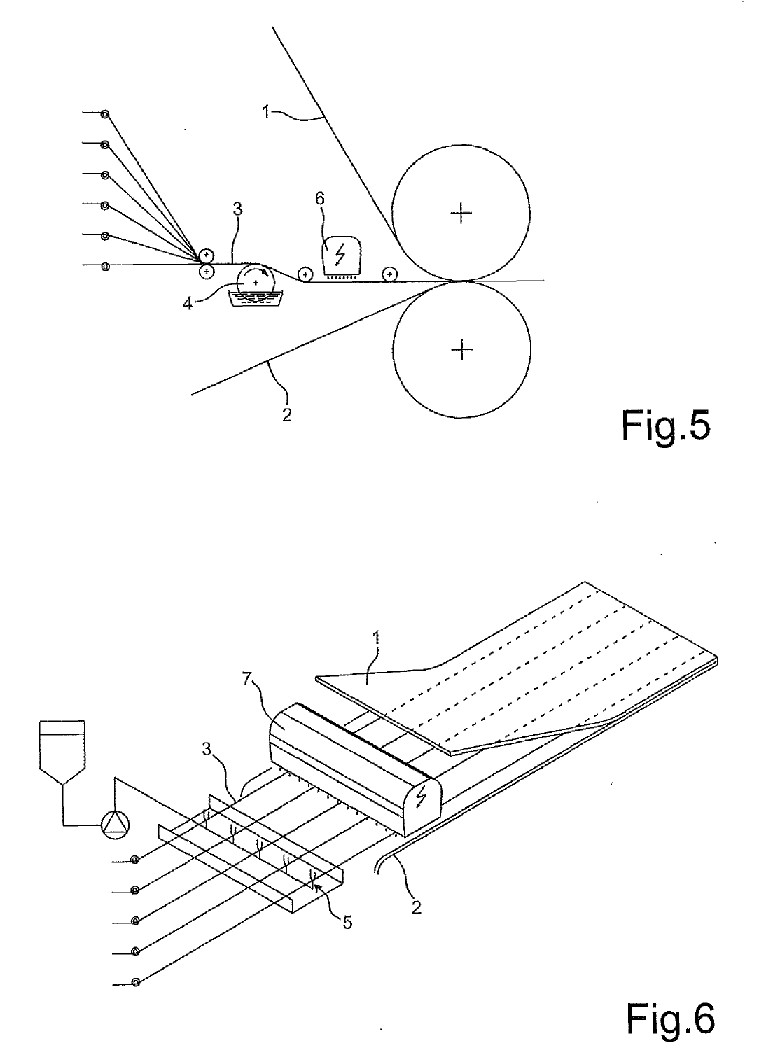

FIGS. 5 and 6 show two alternative procedures for applying the size.

As shown in FIGS. 3 and 4, a textile support according to the present invention can be produced by means of the formation of at least two non-woven textile layers 1 and 2, formed of synthetic polymer flock fibres, oriented in transverse and longitudinal directions, reinforced in the working direction by having said reinforcing filaments 3 resting on one side of, or being inserted between, the above-mentioned layers.

The composite made up of the non-woven textile layers and the reinforcing threads is then consolidated by mechanical needling, undergoes a thermal stabilisation treatment and impregnation with resins, acrylic-based for example, which are polymerised in the subsequent stage of oven-drying.

As an alternative to the polyester flock fibre, it would be possible to use a flock fibre produced from another thermoplastic polymer, such as for example Nylon 6, Nylon 66, PBT or other polymeric material characterised by a melting temperature higher than 230° C.

The reinforcing filaments typically consist of glass fibres, but could also be of other inorganic material, having a Young's modulus greater than 20 GPa and preferably greater than 50 GPa, and are arranged parallel to each other and regularly spaced at between 5 and 30 mm.

The consolidation of the composite formed by the layers of polymer flock fibres and reinforcing filaments is performed by mechanical needling, but could also be performed by bonding with water.

As an alternative to the use of carded flock fibres for forming the layers described above, a spun-bonded process can be used, in which the layers are made up of films of continuous threads deposited on a mesh, by means of an aerodynamic system.

As an alternative to an acrylic type of bonding agent, a pure styrene-, styrol-acrylic- or styrol-butadiene-based resin could be used, or resin mixed with cross-linking agents with a urea-formaldehyde base, or melamine, vinyl or a self-cross-linking resin without formaldehyde.

The bonding material can have a carboxylic —COOH group, capable of creating chemical bonds with a hydroxyl —OH group belonging to the fibres constituting the polymeric layers, so as to improve the mechanical strength of the product.

The reinforcing filaments are treated in advance by the application of a specific additive (size) for increasing the adhesion capacity between polymeric fibre and glass threads, in aqueous solution.

The treatment of the reinforcing filaments can be performed by means of an applicator cylinder (kiss roll) 4 (FIG. 5) or by means of dampening thread guides 5 (FIG. 6), in both cases in combination with a fixative device 6.

The additive mentioned above contains at least a percentage of a silanizing agent, between 0.1% and 20% by weight, typically forming 1% of the solution. The silane can be chosen between various categories such as for example glycidoxypropyltrimethoxysilane or aminopropryl-trimethoxysilane or even another silane belonging to other families not described above, which are distinguished by the functional group of the bond with the resin.

The additive contains furthermore a filmogenic agent, capable of improving the adhesion characteristics between the reinforcing fibre and the polyester matrix and between the glass and the resin, in proportions which can vary between 1% and 20%, typically 7.5%.

By way of demonstration, the graphs in FIG. 2 include a comprehensive, but not exhaustive example which demonstrates the characteristics of a support for a bituminous membrane reinforced with sized glass threads, tried out during laboratory tests conducted at room temperature.

The increase in performance is self-evident; the table below also sets out the increase in absolute terms (expressed in Mpa) of the breaking strain required in the various situations shown in the above-mentioned graphs:

| | untreated | |
|---|---|---|
| | reinforcements | sized reinforcements |
| Traction tests at 25° C. | 4.38 MPa | 5.10 MPa |
| Traction tests at 180° C. | 0.74 MPa | 0.97 MPa |

The textile support thus produced can have a basis weight varying from 50 gsm to 350 gsm, with a percentage of resin as a proportion of the total mass of the support, varying from 5% to 35%.

A support for a bituminous membrane as described above enables significant increases to be achieved in resistance to tolerable strain, therefore improving the dimensional stability of the membranes produced from it.

A support thus produced will be characterised by:
high initial modulus at room temperature,
high modulus at high temperature,
better performance in terms of workability and processability,
greater dimensional stability of the membrane produced.

1. Textile support for bituminous membrane, particularly for the waterproofing of buildings, comprising at least two layers (1,2) of non-woven polyester or polymeric material in general and a plurality of longitudinal reinforcing filaments (3), characterised in that said reinforcing filaments (3) have been treated in advance with a size which permits the formation of stable chemical bonds, not strongly influenced by temperature.

2. Support according to claim 1, characterised in that said non-woven layers (1, 2) and said reinforcing filaments (3) are bonded through the action of at least one bonding material.

3. Support according to claim 2, characterised in that said reinforcing filaments (3) consist of inorganic fibres, preferably glass fibres, possibly combined with polymeric reinforcing filaments.

4. Support according to claim 1, characterised in that said size consists of a mixture of silanizing and filmogenic agents,

5. Support according to claim 4, characterised in that said silanizing agents can belong to the family of organosilanes and are preferentially glycidoxypropyltrimethoxysilane or even aminopropryl-trimethoxysilane.

6. Support according to claim 4, characterised in that said filmogenic agents consist of resins with a base of unsaturated or saturated polyesters or with an epoxy or polyurethane base.

7. Support according to claim 4, characterised in that said size allows the formation of chemical bridges between functional groups (hydroxides or carboxyls or acrylics or epoxies) of the fibres constituting the polymeric matrix, or rather of the impregnating resin and the surface of the fibres constituting the reinforcement.

8. Support according to claim 4, characterised in that the size is applied to the above-mentioned reinforcing filaments by means of cylindrical applicators (4).

9. Support according to claim 4, characterised in that the size is applied to the above-mentioned reinforcing filaments by means of guidable dampeners (5).

10. Support according to claim 8, characterised in that said size is fixed to the surface of the reinforcing filament (3) by means of fixative devices (6) with IR technology, UV wave or even microwave technology, or simply with steam heating or jets of superheated air.

11. Support according to claim 2, characterised in that the resin constituting the bonding material is a self-cross-linking resin without formaldehyde.

12. Support according to claim 1, characterised in that said non-woven layers (1, 2) consist of layers of polymeric and/or synthetic fibres formed by carding of flock fibres.

13. Support according to claim 1, characterised in that said non-woven layers (1, 2) consist of layers of polymeric filaments, formed through direct spinning (spunbonded).

14. Support according to claim 11, wherein the non-woven layers (1, 2) are formed by carding of intimate mixtures of polymeric fibres and low-melting fibres, so as to be suitable for being consolidated by thermal bonding.

15. Support according to claim 12, wherein the non-woven layers (1, 2) are formed from filaments extruded from homopolymer mixed with filaments extruded from low-melting polymer, so as to be suitable for being consolidated by thermal bonding.

16. Support according to claim 1, characterised in that said reinforcing filaments (3) are arranged in a longitudinal and/or diagonal direction.

17. Support according to claim 1, characterised by having a mass per unit area of between 50 gsm and 350 gsm.
